(19) United States
(12) Patent Application Publication
(10) Pub. No.: US 2026/0258757 A1
(43) Pub. Date: Sep. 3, 2026

(54) SINGLE-SHAFT COMBINED CYCLE PLANT CONTROL DEVICE AND SINGLE-SHAFT COMBINED CYCLE PLANT CONTROL METHOD

(71) Applicant: MITSUBISHI HEAVY INDUSTRIES, LTD., Tokyo (JP)

(72) Inventors: Kohei HAYASHI, Tokyo (JP); Kazushige KUWAZURU, Tokyo (JP); Yasutsugu TAKATA, Tokyo (JP); Norihisa KISHI, Kanagawa (JP); Yoji ENDO, Tokyo (JP); Takahiko SAKAKI, Tokyo (JP); Mitsuhiro ADACHI, Tokyo (JP)

(21) Appl. No.: 19/548,018

(22) Filed: Feb. 24, 2026

(30) Foreign Application Priority Data
Mar. 3, 2025 (JP) 2025-032671

(51) Int. Cl. F02C 9/28; F01K 7/16; F02C 6/18

(52) U.S. Cl. CPC F02C 9/28; F01K 7/16; F02C 6/18; F05D 2220/72

(57) ABSTRACT

The present disclosure relates to a single-shaft combined cycle plant control device for controlling a single-shaft combined cycle plant in which a gas turbine connected to a generator and a steam turbine are connectable via a clutch. The single-shaft combined cycle plant control device calculates a gas turbine output on the basis of a generator output calculated based on measurement results of an output current and an output voltage of the generator. A fuel flow rate supplied to the gas turbine is controlled based on a fuel flow rate command value calculated based on the generator output. A combustion state of the gas turbine is controlled based on a combustion state parameter calculated based on the gas turbine output. When a steam turbine trip event is detected while the single-shaft combined cycle plant is operated with the clutch in the connected state, the fuel flow rate command value is maintained constant and the combustion state parameter is maintained constant for a predetermined period from a time of detection of the steam turbine trip event.

### TECHNICAL FIELD

The present disclosure relates to a single-shaft combined cycle plant control device and a single-shaft combined cycle plant control method.

### BACKGROUND

A single-shaft combined cycle plant is known in which a gas turbine and a steam turbine drivable by steam generated using exhaust heat of the gas turbine are connectable to each other via a clutch. For example, Patent Document 1 discloses a single-shaft combined cycle plant in which a steam turbine is connectable to a gas turbine and a generator via a clutch, configured such that when some trouble occurs in the steam turbine, operation of the gas turbine can be continued while stopping only the steam turbine by switching the clutch to a disconnected state.

### CITATION LIST

### Patent Literature

Patent Document 1: JP2003-20913A

### SUMMARY

In Patent Document 1, in the single-shaft combined cycle plant operated with the clutch in the connected state, when a specific trip event occurs, the operation of the gas turbine is enabled to continue by switching the clutch to the disconnected state and stopping only the steam turbine. In this type of single-shaft combined cycle plant, the generator output of the generator connected to the gas turbine and the gas turbine output are calculated using the output current and output voltage of the generator measured by instruments such as an ammeter and a voltmeter, and are used for gas turbine control. However, if the steam turbine output is instantaneously lost upon occurrence of a trip event as described above, the calculated generator output may show transiently unstable behavior during a period from the occurrence of the trip event until a predetermined period elapses. Therefore, if the gas turbine is controlled based on the generator output or the gas turbine output during this period, the control state of the gas turbine may become unstable.

At least one embodiment of the present disclosure has been made in view of the above circumstances, and an object thereof is to provide a single-shaft combined cycle plant control device and a single-shaft combined cycle plant control method whereby it is possible to prevent the control state of a gas turbine from becoming unstable when the steam turbine output is lost upon occurrence of a steam turbine trip event.

In order to solve the above problem, a single-shaft combined cycle plant control device according to at least one embodiment of the present disclosure is a single-shaft combined cycle plant control device for controlling a single-shaft combined cycle plant in which a gas turbine connected to a generator and a steam turbine drivable by steam generated using exhaust heat of the gas turbine are connectable via a clutch, the single-shaft combined cycle plant control device including:
an output calculation unit configured to calculate a gas turbine output on the basis of a generator output calculated based on measurement results of an output current and an output voltage of the generator;
a fuel flow rate command value calculation unit configured to calculate a fuel flow rate command value on the basis of the generator output;
a fuel flow rate control unit configured to control a fuel flow rate supplied to the gas turbine on the basis of the fuel flow rate command value;
a combustion state parameter calculation unit configured to calculate a combustion state parameter of the gas turbine on the basis of the gas turbine output; and
a combustion state control unit configured to control a combustion state of the gas turbine on the basis of the combustion state parameter,
in which, when a steam turbine trip event is detected while the single-shaft combined cycle plant is operated with the clutch in the connected state, the fuel flow rate command value calculation unit maintains the fuel flow rate command value constant for a predetermined period from a time of detection of the steam turbine trip event, and the combustion state parameter calculation unit maintains the combustion state parameter constant for the predetermined period.

In order to solve the above problem, a single-shaft combined cycle plant control method according to at least one embodiment of the present disclosure is a single-shaft combined cycle plant control method for controlling a single-shaft combined cycle plant in which a gas turbine connected to a generator and a steam turbine drivable by steam generated using exhaust heat of the gas turbine are connectable via a clutch, the single-shaft combined cycle plant control method comprising the steps of:
calculating a gas turbine output on the basis of a generator output calculated based on measurement results of an output current and an output voltage of the generator;
calculating a fuel flow rate command value on the basis of the generator output;
controlling a fuel flow rate supplied to the gas turbine on the basis of the fuel flow rate command value;
calculating a combustion state parameter of the gas turbine on the basis of the gas turbine output; and
controlling a combustion state of the gas turbine on the basis of the combustion state parameter,
in which, when a steam turbine trip event is detected while the single-shaft combined cycle plant is operated with the clutch in the connected state, the fuel flow rate command value and the combustion state parameter are maintained constant for a predetermined period from a time of detection of the steam turbine trip event.

At least one embodiment of the present disclosure provides a single-shaft combined cycle plant control device and a single-shaft combined cycle plant control method whereby it is possible to prevent the control state of a gas turbine from becoming unstable when the steam turbine output is lost upon occurrence of a steam turbine trip event.

### BRIEF DESCRIPTION OF DRAWINGS

FIG. 1 is a schematic configuration diagram of a single-shaft combined cycle plant according to an embodiment.

FIG. 2 is a block configuration diagram of the control device of FIG. 1.

FIG. 3 is a configuration diagram of the output calculation unit of FIG. 2.

FIG. 4 is a configuration diagram according to the related art of the gas turbine control unit of FIG. 2.

FIG. 5 is a block diagram showing a configuration of calculation logic of a combustion state parameter in the combustion state parameter calculation unit of FIG. 4.

FIG. 6 is a timing chart showing temporal transitions of a fuel flow rate command value calculated by the fuel flow rate command value calculation unit and a combustion state parameter calculated by the combustion state parameter calculation unit, together with respective outputs calculated by the output calculation unit, before and after the time when an ST trip event occurs in the gas turbine control unit of FIG. 4.

FIG. 7 is a configuration diagram of the gas turbine control unit of FIG. 2.

FIG. 8 is a timing chart showing temporal transitions of a fuel flow rate command value calculated by the fuel flow rate command value calculation unit and a combustion state parameter calculated by the combustion state parameter calculation unit, together with respective outputs calculated by the output calculation unit, before and after the time when an ST trip event occurs in the gas turbine control unit of FIG. 7.

### DETAILED DESCRIPTION

Embodiments of the present invention will now be described in detail with reference to the accompanying drawings. It is intended, however, that unless particularly identified, dimensions, materials, shapes, relative positions, and the like of components described in the embodiments shall be interpreted as illustrative only and not intended to limit the scope of the present invention.

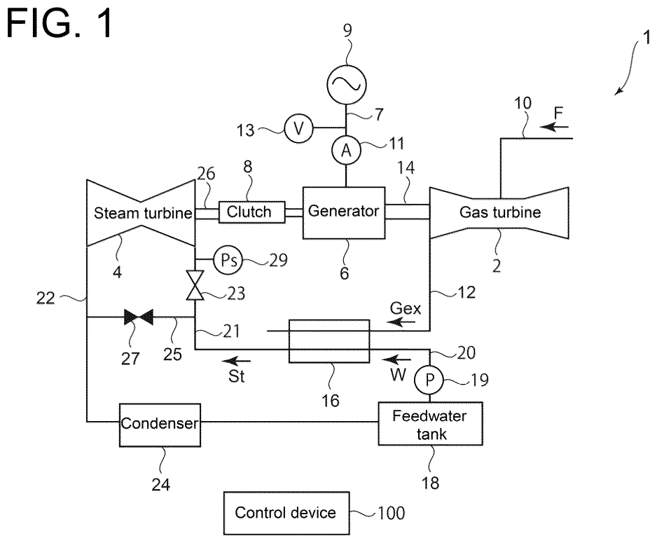

FIG. 1 is a schematic configuration diagram of a single-shaft combined cycle plant 1 according to an embodiment. The single-shaft combined cycle plant 1 includes a gas turbine 2, a steam turbine 4, a generator 6, and a clutch 8.

The gas turbine 2 generates combustion gas by burning fuel F supplied from a fuel supply line 10 of a fuel supply system, and can drive a turbine using the combustion gas. The combustion gas that has finished work by driving the turbine in the gas turbine 2 is discharged to the outside as exhaust gas Gex through an exhaust gas line 12. The generator 6 is connected to an output shaft 14 of the turbine, and can generate power by driving the generator 6 using power output from the turbine.

The generator 6 is electrically connected to an electric power system 9 via a power transmission line 7. The power transmission line 7 is provided with an ammeter 11 for measuring the output current of the generator 6, and a voltmeter 13 for measuring the output voltage of the generator 6.

A heat recovery steam generator 16 (HRSG) is provided in the exhaust gas line 12 of the gas turbine 2. The heat recovery steam generator 16 can generate steam St for driving the steam turbine 4 by heating feedwater W flowing from a feedwater tank 18 through a feedwater line 20, using exhaust heat recovered from the exhaust gas Gex. A feedwater pump 19 for sending the feedwater W from the feedwater tank 18 to the heat recovery steam generator 16 is installed in the feedwater line 20.

The steam St generated in the heat recovery steam generator 16 is supplied to the steam turbine 4 through a steam supply line 21. The steam supply line 21 is provided with a main steam valve 23 for adjusting the flow rate of the steam St supplied to the steam turbine 4. Further, a pressure sensor 29 for detecting the pressure Ps of the steam St supplied to the steam turbine 4 is provided downstream of the main steam valve 23 in the steam supply line 21.

The steam turbine 4 can drive a turbine using the steam St supplied through the steam supply line 21. The steam that has finished work by driving the turbine in the steam turbine 4 is sent to a condenser 24 through a steam recovery line 22. The condenser 24 generates condensate by cooling the steam, and returns it to the feedwater tank 18 as feedwater. Further, when the steam St generated in the heat recovery steam generator 16 is not required in the steam turbine 4, it can be returned to the condenser 24 bypassing the steam turbine 4 via a steam bypass line 25 branching from an upstream side of the main steam valve 23 in the steam supply line 21. A steam bypass valve 27 for adjusting the bypass amount of the steam St is provided on the steam bypass line 25.

An output shaft 26 of the steam turbine 4 is connected to the generator 6 via the clutch 8. The clutch 8 is switchable between the connected state and a disconnected state. When the clutch 8 is in the connected state, both the output shaft 14 of the gas turbine 2 and the output shaft 26 of the steam turbine 4 are connected to the generator 6, and the generator 6 can be driven by both the gas turbine 2 and the steam turbine 4. On the other hand, when the clutch 8 is in the disconnected state, the steam turbine 4 is separated from the generator 6, and although the generator 6 can be driven by output from the gas turbine 2, output from the steam turbine 4 is not transmitted to the generator 6.

Further, the single-shaft combined cycle plant 1 includes a control device 100 for controlling each of the above configurations. The control device 100 is a control unit for the single-shaft combined cycle plant 1 and includes, for example, a central processing unit (CPU), a random access memory (RAM), a read only memory (ROM), and a computer-readable storage medium or the like. Then, a series of processes for realizing various functions is stored in the storage medium or the like in the form of a program, as an example. The CPU reads the program out to the RAM or the like and executes processing/calculation of information, thereby realizing the various functions. A configuration where the program is installed in the ROM or another storage medium in advance, a configuration where the program is provided in a state of being stored in the computer-readable storage medium, a configuration where the program is distributed via a wired or wireless communication means, etc., may be applied. The computer-readable storage medium may be a magnetic disk, a magneto-optical disk, a CD-ROM, a DVD-ROM, or a semiconductor memory.

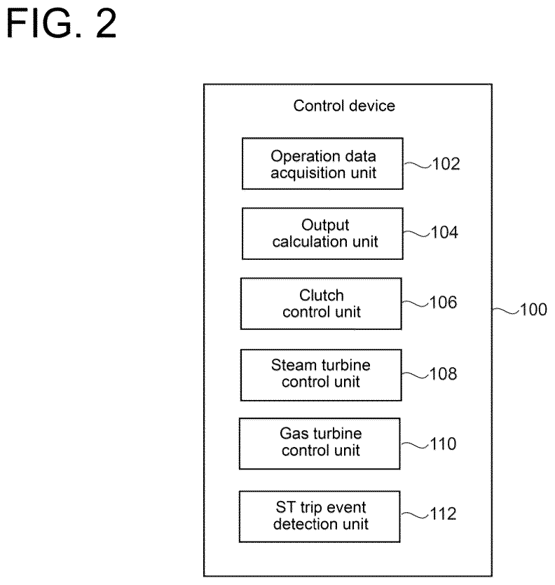

FIG. 2 is a block diagram of the control device 100 of FIG. 1. The control device 100 includes an operation data acquisition unit 102, an output calculation unit 104, a clutch control unit 106, a steam turbine control unit 108, a gas turbine control unit 110, and an ST trip event detection unit 112.

The operation data acquisition unit 102 is configured to acquire operation data of the single-shaft combined cycle plant 1. The operation data can broadly include data regarding the operation state of the single-shaft combined cycle plant 1, and may be actually measured values detectable by various sensors, data values of various control signals when operating the single-shaft combined cycle plant 1 in the control device 100, or calculated values calculatable based on these.

The output calculation unit 104 is configured to calculate each of the output of the generator 6 (hereinafter, appropriately referred to as “generator output Lgen”), the output of the steam turbine 4 (hereinafter, appropriately referred to as “steam turbine output Lst”), and the output of the gas turbine 2 (hereinafter, appropriately referred to as “gas turbine output Lgt”).

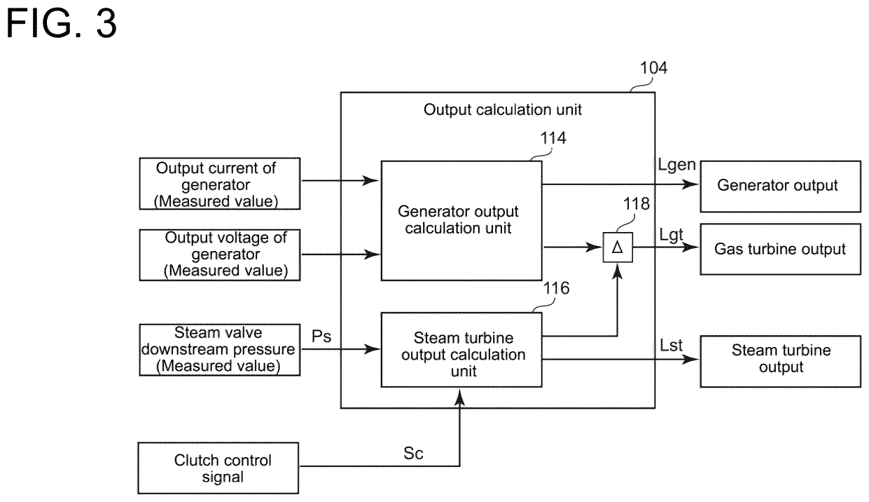

FIG. 3 is a configuration diagram of the output calculation unit 104 of FIG. 2. The output calculation unit 104 includes a generator output calculation unit 114, a steam turbine output calculation unit 116, and a subtractor 118.

The generator output calculation unit 114 is configured to calculate the generator output Lgen on the basis of the output current of the generator 6 measured by the ammeter 11 and the output voltage of the generator 6 measured by the voltmeter 13. Specifically, the generator output calculation unit 114 calculates the generator output Lgen by multiplying the output current of the generator 6 measured by the ammeter 11 and the output voltage of the generator 6 measured by the voltmeter 13.

The steam turbine output calculation unit 116 is configured to calculate the steam turbine output Lst on the basis of the pressure Ps of the steam St detected by the pressure sensor 29. Specifically, the steam turbine output calculation unit 116 has in advance a characteristic function (not shown) that defines a correlation between the pressure Ps and the steam turbine output Lst, and can obtain the steam turbine output Lst by inputting the pressure Ps detected by the pressure sensor 29 into the characteristic function.

The generator output Lgen calculated by the generator output calculation unit 114 and the steam turbine output Lst calculated by the steam turbine output calculation unit 116 are input to the subtractor 118, whereby the gas turbine output Lgt is calculated as a difference between the two. That is, the gas turbine output Lgt is calculated by the following equation.

$$Lgt = Lgen - Lst \qquad ( 1 )$$

A clutch control signal Sc is input from the clutch control unit 106 to the steam turbine output calculation unit 116. The clutch control signal Sc is a binary signal indicating the control state (connected state or disconnected state) of the clutch 8 by the clutch control unit 106. When it is determined that the clutch 8 is in the disconnected state based on the clutch control signal Sc, the steam turbine output calculation unit 116 outputs zero as the steam turbine output Lst regardless of the pressure Ps detected by the pressure sensor 29. In this case, according to the above equation (1), the gas turbine output Lgt calculated by the output calculation unit 104 becomes equal to the generator output Lgen.

Returning to FIG. 2, the clutch control unit 106 is configured to control the clutch 8. During normal operation of the single-shaft combined cycle plant 1, the clutch control unit 106 controls the clutch 8 to the connected state. That is, during normal operation, the gas turbine 2, the steam turbine 4, and the generator 6 are connected to each other. On the other hand, during normal operation, if a trip event in which the steam turbine 4 should be stopped (hereinafter, appropriately referred to as “ST trip event T”) occurs as described later, the clutch 8 automatically enters the disconnected state as the rotation speed of the steam turbine 4 decreases in accordance with stop control of the steam turbine 4. This allows the steam turbine 4 to be disconnected from the gas turbine 2 and the generator 6, so that only the steam turbine 4 can be stopped while the gas turbine 2 continues to operate.

Further, the clutch control unit 106 outputs the clutch control signal Sc, which is a binary signal indicating the control state (connected state or disconnected state) of the clutch 8. The clutch control signal Sc output from the clutch control unit 106 can be appropriately referred to in other configurations of the control device 100 including the aforementioned output calculation unit 104.

The steam turbine control unit 108 is configured to control the steam turbine 4. Specific control contents of the steam turbine 4 follow publicly known examples, and detailed description thereof is omitted, but the operation state of the steam turbine 4 is controlled by adjusting the flow rate, temperature, pressure, etc. of the steam St supplied to the steam turbine 4, for example, by controlling the opening degrees of the main steam valve 23 and the steam bypass valve 27, and the operation state of the heat recovery steam generator 16.

Further, when the ST trip event T described later is detected by the ST trip event detection unit 112, the steam turbine control unit 108 performs control to stop the normally operated steam turbine 4. At this time, the steam turbine control unit 108 synchronizes with the clutch control unit 106 to perform stop control of the steam turbine 4 on the condition that the clutch 8 has been switched to the disconnected state by the clutch control unit 106.

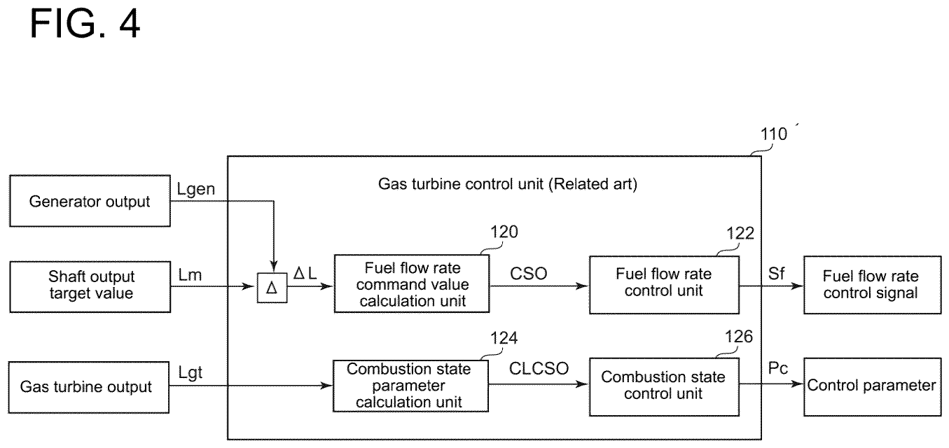

The gas turbine control unit 110 is configured to control the gas turbine 2. Here, a configuration according to a related art of the gas turbine control unit 110 will be described with reference to FIG. 4. FIG. 4 is a configuration diagram according to the related art of the gas turbine control unit 110 of FIG. 2. In the following description, the gas turbine control unit according to the related art is denoted by reference sign 110′ in order to distinguish it from the gas turbine control unit 110 according to the present embodiment.

The gas turbine control unit 110′ includes a fuel flow rate command value calculation unit 120, a fuel flow rate control unit 122, a combustion state parameter calculation unit 124, and a combustion state control unit 126.

The fuel flow rate command value calculation unit 120 is configured to calculate a fuel flow rate command value CSO which is a command value regarding the fuel flow rate supplied from the fuel supply system to the gas turbine 2. The fuel flow rate command value CSO is calculated based on a difference ΔL (=Lgen−Lm) between the generator output Lgen calculated by the output calculation unit 104 and a shaft output target value Lm. The shaft output target value Lm is a target value regarding the shaft output of the single-shaft combined cycle plant 1, and for example, a value distributed from a central power control room according to the supply and demand state of the electric power system is input. In the present embodiment, in order to simplify the description, it is assumed that the shaft output target value Lm is constant.

The fuel flow rate control unit 122 is configured to control the flow rate of fuel supplied to the gas turbine 2 through the fuel supply line 10 on the basis of the fuel flow rate command value CSO calculated by the fuel flow rate command value calculation unit 120. The fuel flow rate control unit 122 targets a configuration for adjusting the fuel supplied to the gas turbine 2 for control, and for example, targets each valve (shutoff valve or flow regulating valve) provided in the fuel supply line 10 of the fuel supply system for control. The fuel flow rate control unit 122 generates a fuel flow rate control signal Sf for controlling these control targets, and outputs the fuel flow rate control signal Sf to the control targets, thereby implementing control of the fuel flow rate in the fuel supply line 10.

The combustion state parameter calculation unit 124 is configured to calculate a combustion state parameter indicating the combustion state of the gas turbine 2 on the basis of the gas turbine output Lgt calculated by the output calculation unit 104. The present embodiment describes a case where an index CLCSO corresponding to the turbine inlet temperature T1T of the gas turbine is calculated as an example of the combustion state parameter, but the combustion state parameter is not limited thereto (hereinafter, appropriately referred to as “combustion state parameter CLCSO”).

The combustion state parameter CLCSO is a parameter obtained by non-dimensionalizing the turbine inlet temperature T1T of the gas turbine 2, and is a parameter having a positive correlation with the turbine inlet temperature T1T (proportional to the turbine inlet temperature T1T). The combustion state parameter CLCSO is set to be 0% when the turbine inlet temperature T1T is a lower limit value, and 100% when the turbine inlet temperature T1T is an upper limit value. For example, when the lower limit value of the turbine inlet temperature T1T is 700° C. and the upper limit value of the turbine inlet temperature T1T is 1500° C., the combustion state parameter CLCSO is expressed by the following equation (2).

$$C L C S O ( \% ) = \{ ( Lgt - 700 ° C . MW ) / ( 1500 ° C . MW - 700 ° C . MW ) \} \times 100 \qquad ( 2 )$$

700° C. MW is the gas turbine output Lgt when the turbine inlet temperature T1T is 700° C. which is the lower limit value in the environment of the gas turbine 2 at the present time. Further, 1500° C. MW is the gas turbine output Lgt when the turbine inlet temperature T1T is 1500° C. which is the upper limit value in the environment of the gas turbine 2 at the present time.

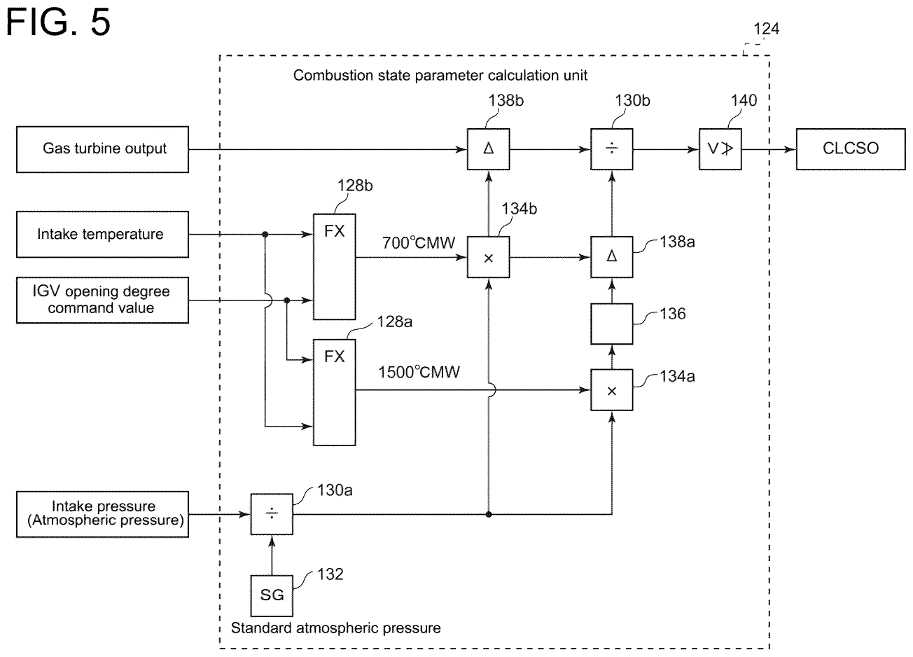

Here, calculation logic of the combustion state parameter CLCSO will be described in detail. FIG. 5 is a block diagram showing a configuration of calculation logic of the combustion state parameter CLCSO in the combustion state parameter calculation unit 124 of FIG. 4. In this calculation logic, the combustion state parameter CLCSO is calculated based on an intake air temperature of a compressor included in the gas turbine 2, an opening degree command value of an inlet guide vane (IGV) included in the gas turbine 2, and an intake pressure (atmospheric pressure) of the compressor included in the gas turbine 2, which are acquired as operation data by the operation data acquisition unit 102, in addition to the gas turbine output Lgt calculated by the output calculation unit 104.

The IGV opening degree command value is a signal command value sent from an IGV control device (not shown) for controlling the inlet guide vane, but for example, when the IGV opening degree can be measured, it may be a measured value of the IGV opening degree.

First, a function generator 128a calculates a value of 1500° C. MW (temperature control MW) on the basis of the intake air temperature and the IGV opening degree command value which are the operation data acquired by the operation data acquisition unit 102. That is, the value of 1500° C. MW considering the IGV opening degree and the intake air temperature is obtained.

A function generator 128b calculates a value of 700° C. MW on the basis of the intake air temperature and the IGV opening degree command value which are the operation data acquired by the operation data acquisition unit 102. That is, the value of 700° C. MW considering the IGV opening degree and the intake air temperature is obtained.

A divider 130a divides the intake pressure (atmospheric pressure) which is the operation data acquired by the operation data acquisition unit 102 by the standard atmospheric pressure set by a signal generator 132 to obtain the atmospheric pressure ratio (intake pressure/standard atmospheric pressure). A multiplier 134a multiplies the value of 1500° C. MW obtained by the function generator 128a and the atmospheric pressure ratio obtained by the divider 130a to obtain a value of 1500° C. MW also considering the atmospheric pressure ratio.

The value of 1500° C. MW obtained by the multiplier 134a is output to a subtractor 138a via a learning circuit 136. The learning circuit 136 is for correcting a deviation in the value of 1500° C. MW caused by characteristic deterioration or the like of the gas turbine 2. A multiplier 134b multiplies the value of 700° C. MW obtained by the function generator 128b and the atmospheric pressure ratio obtained by the divider 130a to obtain a value of 700° C. MW also considering the atmospheric pressure ratio.

The subtractor 138a subtracts the value of 700° C. MW obtained by the multiplier 134b from the value of 1500° C. MW corrected by the learning circuit 136 (1500° C. MW- 700° C. MW: see equation (2) above). A subtractor 138b subtracts the value of 700° C. MW obtained by the multiplier 134b from the gas turbine output Lgt calculated by the output calculation unit 104 (Actual output −700° C. MW: see equation (2) above).

A divider 130b divides a subtraction result of the subtractor 138b by a subtraction result of the subtractor 138a (see equation (2) above) to calculate the combustion state parameter CLCSO. When the combustion state parameter CLCSO is expressed in percentage, the output value of the divider 130b is multiplied by 100.

In a rate setter 140, in order to prevent respective valves and the like for adjusting the fuel flow rate from frequently repeating opening and closing operations due to minute fluctuations in the combustion state parameter CLCSO caused by minute fluctuations in the gas turbine output Lgt or the like, an input value from the divider 130b is not immediately output as the combustion state parameter CLCSO, but is output by limiting to a predetermined increase/decrease rate.

Returning to FIG. 4, the combustion state control unit 126 is configured to control the combustion state of the gas turbine 2 on the basis of the combustion state parameter CLCSO calculated by the combustion state parameter calculation unit 124. The combustion state control unit 126 calculates a control parameter Pc for operating various control terminals of the gas turbine 2 on the basis of the combustion state parameter CLCSO. The control parameter Pc is not limited, but is, for example, a fuel distribution ratio for respective fuel injection nozzles included in the combustor of the gas turbine 2, or an opening degree command value of the inlet guide vane IGV provided in the compressor of the gas turbine 2.

Returning to FIG. 2, the ST trip event detection unit 112 is configured to detect a steam turbine trip event (hereinafter, appropriately referred to as “ST trip event T”). The ST trip event T is a trip event in which, in the single-shaft combined cycle plant 1 normally operated with the clutch 8 in the connected state, stopping of the steam turbine 4 is requested while continuing operation of the gas turbine 2 on the condition that the clutch 8 is switched to the disconnected state. That is, the ST trip event T is a trip event in which stopping of the steam turbine 4 is requested upon its occurrence, while stopping of the gas turbine 2 is not requested.

As an example of such an ST trip event T, there is a trip event regarding a decrease in vacuum degree of the condenser 24. In particular, when the condenser 24 is an air-cooled condenser (ACC), there is a large difference between a first trip event in which the vacuum degree decreases to a first reference value or less and a second trip event (protection trip event) in which the vacuum degree decreases to a second reference value or less which is lower than the first reference value (that is, a difference between the first reference value and the second reference value is large). Therefore, in the air-cooled condenser, when the vacuum degree becomes less than the first reference value but is equal to or higher than the second reference value, it is not necessary to stop the entire single-shaft combined cycle plant 1, and it is sufficient to stop only the steam turbine 4.

Further, as another example of the ST trip event T, there is an event in which an abnormality occurs in an auxiliary machine system of the steam turbine 4. For example, a state where an emergency shutoff operation is impossible due to a hydraulic pressure in a hydraulic system for emergency shutoff of the steam turbine 4 decreasing to a reference value or less is a problem of the steam turbine 4 alone. Therefore, it is not necessary to stop the entire single-shaft combined cycle plant 1, and it is sufficient to stop only the steam turbine 4.

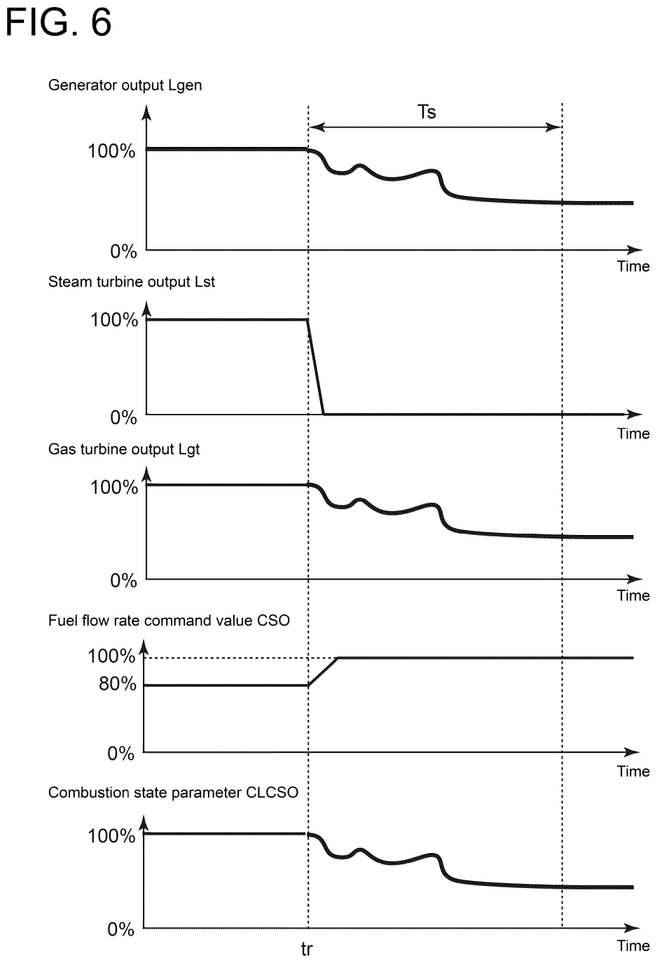

FIG. 6 is a timing chart showing temporal transitions of the fuel flow rate command value CSO calculated by the fuel flow rate command value calculation unit 120 and the combustion state parameter CLCSO calculated by the combustion state parameter calculation unit 124, together with respective outputs (generator output Lgen, steam turbine output Lst, and gas turbine output Lgt) calculated by the output calculation unit 104, before and after time tr when the ST trip event T occurs in the gas turbine control unit 110′ of FIG. 4. FIG. 6 shows a case where the ST trip event T occurs at time tr in the single-shaft combined cycle plant 1 which is in normal operation with the clutch 8 in the connected state and both the gas turbine output Lgt and the steam turbine output Lst at the rated output (100%) as an initial state.

When the ST trip event T occurs at time tr, as described above, the clutch 8 is quickly switched to the disconnected state by the clutch control unit 106, and the steam turbine 4 is promptly stopped by the steam turbine control unit 108. At this time, the generator output Lgen calculated by the output calculation unit 104 is calculated based on the output power measured by the ammeter 11 and the output voltage measured by the voltmeter 13 as described above, but if the steam turbine output Lst is instantaneously lost at time tr, it shows transiently unstable behavior (although it is inferred that the actual generator output Lgen and gas turbine output Lgt are relatively stable even if the steam turbine output Lst is instantaneously lost at time tr, the generator output Lgen and the gas turbine output Lgt calculated by the output calculation unit 104 show unstable behavior). This unstable behavior converges and is eventually resolved as the predetermined period Ts elapses from time tr, but during the predetermined period Ts, the gas turbine output Lgt calculated by the output calculation unit 104 so as to correspond to the generator output Lgen also shows unstable behavior.

Thus, in the predetermined period Ts from time tr, the generator output Lgen and the gas turbine output Lgt calculated by the output calculation unit 104 become unstable. Therefore, since the fuel flow rate command value CSO and the combustion state parameter CLCSO calculated using the generator output Lgen and the gas turbine output Lgt also become unstable, there is a possibility that the control state of the gas turbine 2 becomes unstable. Such a problem can be suitably resolved by the embodiments described below.

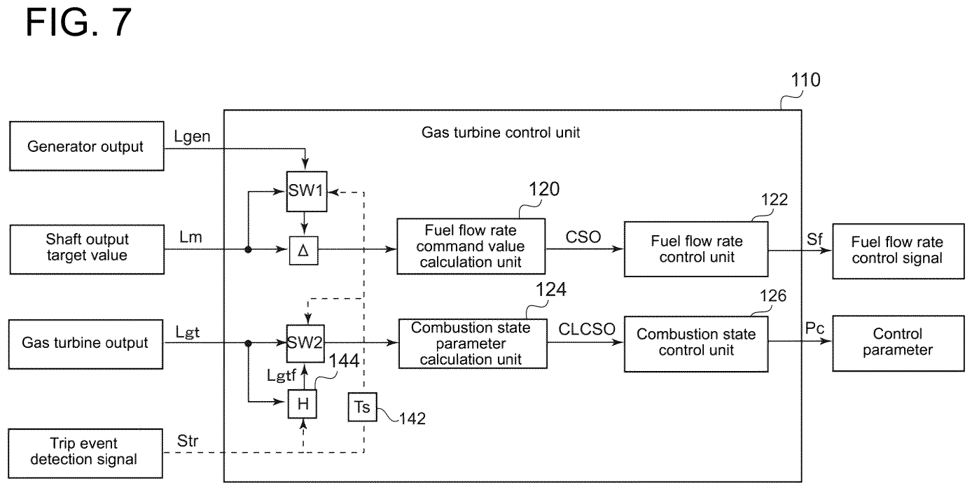

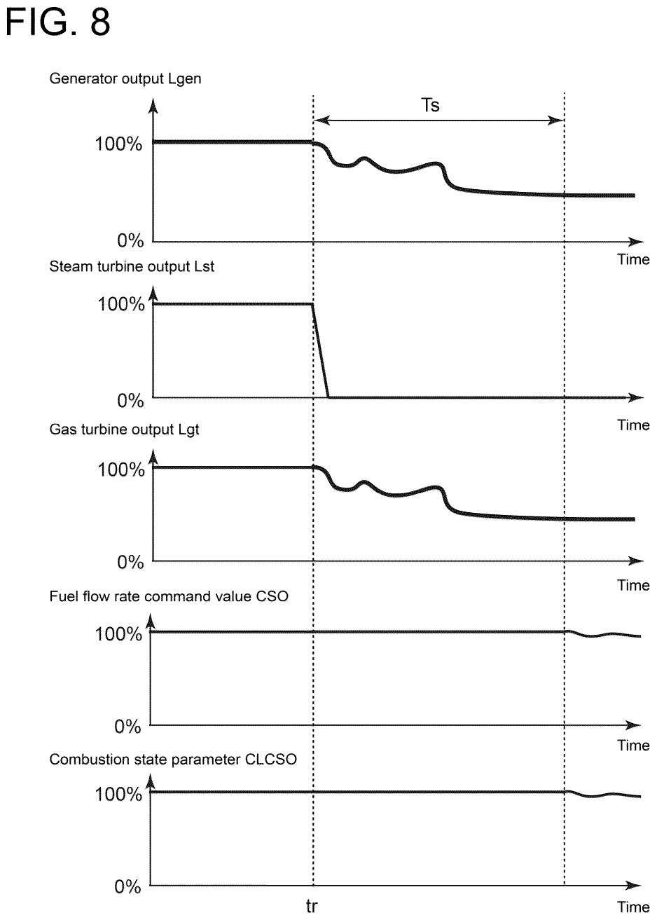

FIG. 7 is a configuration diagram of the gas turbine control unit 110 of FIG. 2, and FIG. 8 is a timing chart showing temporal transitions of the fuel flow rate command value CSO calculated by the fuel flow rate command value calculation unit 120 and the combustion state parameter CLCSO calculated by the combustion state parameter calculation unit 124, together with respective outputs (generator output Lgen, steam turbine output Lst, and gas turbine output Lgt) calculated by the output calculation unit 104, before and after time tr when the ST trip event T occurs in the gas turbine control unit 110 of FIG. 7. In the following description, configurations common to the gas turbine control unit 110′ according to the related art described above with reference to FIG. 4 are denoted by common reference signs, and overlapping description will be omitted unless otherwise specified.

When the ST trip event T occurs at time tr, the gas turbine control unit 110 maintains the fuel flow rate command value CSO calculated by the fuel flow rate command value calculation unit 120 at a constant value for the predetermined period Ts from time tr, and maintains the combustion state parameter CLCSO calculated by the combustion state parameter calculation unit 124 at a value corresponding to a previous calculated value of the gas turbine output Lgt based on time tr (that is, a value immediately before time tr). Thus, as described above with reference to FIG. 6, in the predetermined period Ts in which the generator output Lgen and the gas turbine output Lgt calculated by the output calculation unit 104 become unstable, regardless of calculation results of the output calculation unit 104, it is possible to suitably prevent the control state of the gas turbine 2 from becoming unstable by maintaining the fuel flow rate command value CSO and the combustion state parameter CLCSO constant.

Specifically describing based on the block configuration shown in FIG. 7, when the ST trip event T is detected at time tr by the ST trip event detection unit 112, an ST trip event detection signal Str is input from the ST trip event detection unit 112 to the gas turbine control unit 110. When the ST trip event detection signal Str is input to the gas turbine control unit 110, the timer circuit 142 outputs an ON signal for the predetermined period Ts from time tr.

The first switch SW1 can selectively switch between the generator output Lgen and the shaft output target value Lm. When the ON signal is not input from the timer circuit 142 to the first switch SW1, the first switch SW1 is switched to select the generator output Lgen, and a difference ΔL between the generator output Lgen and the shaft output target value Lm is input to the fuel flow rate command value calculation unit 120, similarly to the aforementioned related art (see FIG. 4). In this case, in the fuel flow rate command value calculation unit 120, the fuel flow rate command value CSO is calculated based on the generator output Lgen calculated by the output calculation unit 104.

On the other hand, when the ON signal is input from the timer circuit 142 to the first switch SW1, the first switch SW1 is switched to select the shaft output target value Lm instead of the generator output Lgen. Thus, since a difference ΔL=0 between the shaft output target values Lm is input to the fuel flow rate command value calculation unit 120, the fuel flow rate command value CSO calculated by the fuel flow rate command value calculation unit 120 is maintained constant.

The second switch SW2 can selectively switch between the gas turbine output Lgt calculated by the output calculation unit 104 and the gas turbine output Lgt held by the hold circuit 144 (hereinafter, appropriately referred to as “gas turbine output fixed value Lgtf”). The hold circuit 144 maintains the previous calculated value of the gas turbine output Lgt in the output calculation unit 104 based on time tr (that is, the value immediately before time tr) as the gas turbine output fixed value Lgtf, triggered by the input of the ST trip event detection signal Str at time tr.

When the ON signal is not input from the timer circuit 142 to the second switch SW2, the second switch SW2 is switched to select the gas turbine output Lgt, and the gas turbine output Lgt is input to the combustion state parameter calculation unit 124, similarly to the aforementioned related art (see FIG. 4). In this case, in the combustion state parameter calculation unit 124, the combustion state parameter CLCSO is calculated based on the gas turbine output Lgt calculated by the output calculation unit 104.

On the other hand, when the ON signal is input from the timer circuit 142 to the second switch SW2, the second switch SW2 is switched to select the gas turbine output fixed value Lgtf instead of the gas turbine output Lgt. Thus, since the gas turbine output fixed value Lgtf, which is the previous calculated value of the gas turbine output in the output calculation unit 104 based on time tr, is input to the combustion state parameter calculation unit 124, the combustion state parameter CLCSO is prevented from being affected by the gas turbine output Lgt showing unstable behavior in the predetermined period Ts.

The present disclosure is not limited to the embodiments described above, but includes modifications to the embodiments described above, and embodiments composed of combinations of those embodiments.

The contents described in the above embodiments would be understood as follows, for instance.

(1) A single-shaft combined cycle plant control device according to one aspect is a single-shaft combined cycle plant control device for controlling a single-shaft combined cycle plant in which a gas turbine connected to a generator and a steam turbine drivable by steam generated using exhaust heat of the gas turbine are connectable via a clutch, the single-shaft combined cycle plant control device including:
an output calculation unit configured to calculate a gas turbine output on the basis of a generator output calculated based on measurement results of an output current and an output voltage of the generator;
a fuel flow rate command value calculation unit configured to calculate a fuel flow rate command value on the basis of the generator output;
a fuel flow rate control unit configured to control a fuel flow rate supplied to the gas turbine on the basis of the fuel flow rate command value;
a combustion state parameter calculation unit configured to calculate a combustion state parameter of the gas turbine on the basis of the gas turbine output; and
a combustion state control unit configured to control a combustion state of the gas turbine on the basis of the combustion state parameter,
in which, when a steam turbine trip event is detected while the single-shaft combined cycle plant is operated with the clutch in the connected state, the fuel flow rate command value calculation unit maintains the fuel flow rate command value constant for a predetermined period from a time of detection of the steam turbine trip event, and the combustion state parameter calculation unit maintains the combustion state parameter constant for the predetermined period.

According to the above aspect (1), when a steam turbine trip event occurs in the single-shaft combined cycle plant operated with the clutch in the connected state, the fuel flow rate command value and the combustion state parameter are maintained constant for a predetermined period from the time of detection of the steam turbine trip event. Thus, even if the generator output and the gas turbine output calculated by the output calculation unit become unstable due to instantaneous loss of the steam turbine output by stopping the steam turbine while switching the clutch to the disconnected state, the control state of the gas turbine can be stably maintained by maintaining the fuel flow rate command value and the combustion state parameter calculated from the generator output and the gas turbine output constant.

(2) In another aspect, in the above aspect (1), when the steam turbine trip event is detected while the single-shaft combined cycle plant is operated with the clutch in the connected state, the combustion state parameter calculation unit uses, as the gas turbine output, a previous calculated value of the gas turbine output at the time of detection of the steam turbine trip event over the predetermined period.

According to the above aspect (2), during the predetermined period from the time of detection of the steam turbine trip event, the previous calculated value of the gas turbine output at the time of detection of the steam turbine trip event (that is, the value immediately before the steam turbine trip event is detected in the output calculation unit) is used as the gas turbine output used for calculating the combustion state parameter. Thus, in the predetermined period in which the gas turbine output calculated by the output calculation unit becomes unstable, the gas turbine output used for calculating the combustion state parameter can be suitably stabilized.

(3) In another aspect, in the above aspect (1) or (2), the fuel flow rate command value calculation unit is configured to calculate the fuel flow rate command value on the basis of a difference between the generator output and a target output value corresponding to the generator output, and when the steam turbine trip event is detected while the single-shaft combined cycle plant is operated with the clutch in the connected state, the target output value is used as the generator output over the predetermined period.

According to the above aspect (3), during the predetermined period from the time of detection of the steam turbine trip event, the target output value corresponding to the generator output is used as the generator output used for calculating the fuel flow rate command value. Thus, when calculating the fuel flow rate command value on the basis of the difference between the generator output and the target output value, the fuel flow rate command value can be suitably maintained constant by making the difference zero.

(4) In another aspect, in any one of the above aspects (1) to (3), after the predetermined period has elapsed from the time of detection of the steam turbine trip event, maintenance of the fuel flow rate command value by the fuel flow rate command value calculation unit and maintenance of the combustion state parameter by the combustion state parameter calculation unit are released.

According to the above aspect (4), as described above, maintenance of the fuel flow rate command value and the combustion state parameter, which have been maintained constant for the predetermined period from the time of detection of the steam turbine trip event, is released after the predetermined period has elapsed. This allows a stable transition to a state where power can be generated by the generator with the output of the gas turbine.

(5) In another aspect, in any one of the above aspects (1) to (4), the steam turbine trip event is at least one of a decrease in vacuum degree in an air-cooled condenser for generating condensate from steam discharged from the steam turbine, or an abnormality in an auxiliary machine of the steam turbine.

According to the above aspect (5), when these steam turbine trip events occur in the single-shaft combined cycle plant operated with the clutch in the connected state, it is possible to suitably prevent the control state of the gas turbine from becoming unstable when the steam turbine is stopped while switching the clutch to the disconnected state.

(6) In another aspect, in any one of the above aspects (1) to (5), the combustion state parameter is a value obtained by non-dimensionalizing a turbine inlet temperature of the gas turbine.

According to the above aspect (6), by using the value obtained by non-dimensionalizing the turbine inlet temperature of the gas turbine as the combustion state parameter indicating the combustion state of the gas turbine, the gas turbine can be satisfactorily controlled without actually measuring the turbine inlet temperature.

(7) In another aspect, in any one of the above aspects (1) to (6), the combustion state control unit is configured to control, as the combustion state, at least one of a fuel distribution ratio for a plurality of fuel injection nozzles of the gas turbine or an opening degree of an inlet guide vane provided in a compressor of the gas turbine.

According to the above aspect (7), the combustion state of the gas turbine can be suitably controlled by setting the fuel distribution ratio and the opening degree of the inlet guide vane as control targets on the basis of the combustion state parameter.

(8) A single-shaft combined cycle plant control method according to one aspect is a single-shaft combined cycle plant control method for controlling a single-shaft combined cycle plant in which a gas turbine connected to a generator and a steam turbine drivable by steam generated using exhaust heat of the gas turbine are connectable through a clutch, the single-shaft combined cycle plant control method including the steps of:
calculating a gas turbine output on the basis of a generator output calculated based on measurement results of an output current and an output voltage of the generator;
calculating a fuel flow rate command value on the basis of the generator output;
controlling a fuel flow rate supplied to the gas turbine on the basis of the fuel flow rate command value;
calculating a combustion state parameter of the gas turbine on the basis of the gas turbine output; and
controlling a combustion state of the gas turbine on the basis of the combustion state parameter,
in which, when a steam turbine trip event is detected while the single-shaft combined cycle plant is operated with the clutch in the connected state, the fuel flow rate command value and the combustion state parameter are maintained constant for a predetermined period from a time of detection of the steam turbine trip event.

According to the above aspect (8), when a steam turbine trip event occurs in the single-shaft combined cycle plant operated with the clutch in the connected state, the fuel flow rate command value and the combustion state parameter are maintained constant for a predetermined period from the time of detection of the steam turbine trip event. Thus, even if the generator output and the gas turbine output calculated by the output calculation unit become unstable due to instantaneous loss of the steam turbine output by stopping the steam turbine while switching the clutch to the disconnected state, the control state of the gas turbine can be stably maintained by maintaining the fuel flow rate command value and the combustion state parameter calculated from the generator output and the gas turbine output constant.

1. A single-shaft combined cycle plant control device for controlling a single-shaft combined cycle plant in which a gas turbine connected to a generator and a steam turbine drivable by steam generated using exhaust heat of the gas turbine are connectable via a clutch, the single-shaft combined cycle plant control device comprising:
an output calculation unit configured to calculate a gas turbine output on the basis of a generator output calculated based on measurement results of an output current and an output voltage of the generator;
a fuel flow rate command value calculation unit configured to calculate a fuel flow rate command value on the basis of the generator output;
a fuel flow rate control unit configured to control a fuel flow rate supplied to the gas turbine on the basis of the fuel flow rate command value;
a combustion state parameter calculation unit configured to calculate a combustion state parameter of the gas turbine on the basis of the gas turbine output; and
a combustion state control unit configured to control a combustion state of the gas turbine on the basis of the combustion state parameter,
wherein, when a steam turbine trip event is detected while the single-shaft combined cycle plant is operated with the clutch in the connected state, the fuel flow rate command value calculation unit maintains the fuel flow rate command value constant for a predetermined period from a time of detection of the steam turbine trip event, and the combustion state parameter calculation unit maintains the combustion state parameter constant for the predetermined period.

2. The single-shaft combined cycle plant control device according to claim 1,
wherein, when the steam turbine trip event is detected while the single-shaft combined cycle plant is operated with the clutch in the connected state, the combustion state parameter calculation unit uses, as the gas turbine output, a previous calculated value of the gas turbine output at the time of detection of the steam turbine trip event over the predetermined period.

3. The single-shaft combined cycle plant control device according to claim 1,
wherein the fuel flow rate command value calculation unit is configured to calculate the fuel flow rate command value on the basis of a difference between the generator output and a target output value corresponding to the generator output, and
wherein, when the steam turbine trip event is detected while the single-shaft combined cycle plant is operated with the clutch in the connected state, the target output value is used as the generator output over the predetermined period.

4. The single-shaft combined cycle plant control device according to claim 1,
wherein, after the predetermined period has elapsed from the time of detection of the steam turbine trip event, maintenance of the fuel flow rate command value by the fuel flow rate command value calculation unit and maintenance of the combustion state parameter by the combustion state parameter calculation unit are released.

5. The single-shaft combined cycle plant control device according to claim 1,
wherein the steam turbine trip event is at least one of a decrease in vacuum degree in an air-cooled condenser for generating condensate from steam discharged from the steam turbine, or an abnormality in an auxiliary machine of the steam turbine.

6. The single-shaft combined cycle plant control device according to claim 1,
wherein the combustion state parameter is a value obtained by non-dimensionalizing a turbine inlet temperature of the gas turbine.

7. The single-shaft combined cycle plant control device according to claim 1,
wherein the combustion state control unit is configured to control, as the combustion state, at least one of a fuel distribution ratio for a plurality of fuel injection nozzles of the gas turbine or an opening degree of an inlet guide vane provided in a compressor of the gas turbine.

8. A single-shaft combined cycle plant control method for controlling a single-shaft combined cycle plant in which a gas turbine connected to a generator and a steam turbine drivable by steam generated using exhaust heat of the gas turbine are connectable via a clutch, the single-shaft combined cycle plant control method comprising the steps of:
calculating a gas turbine output on the basis of a generator output calculated based on measurement results of an output current and an output voltage of the generator;
calculating a fuel flow rate command value on the basis of the generator output;
controlling a fuel flow rate supplied to the gas turbine on the basis of the fuel flow rate command value;
calculating a combustion state parameter of the gas turbine on the basis of the gas turbine output; and
controlling a combustion state of the gas turbine on the basis of the combustion state parameter,
wherein, when a steam turbine trip event is detected while the single-shaft combined cycle plant is operated with the clutch in the connected state, the fuel flow rate command value and the combustion state parameter are maintained constant for a predetermined period from a time of detection of the steam turbine trip event.
